(19) United States
(12) Patent Application Publication
(10) Pub. No.: US 2006/0082691 A1
(43) Pub. Date: Apr. 20, 2006

(54) Image display apparatus

(75) Inventor: Yasushi Tanijiri, Osakasayama-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS,INC.

(21) Appl. No.: 11/060,270

(22) Filed: Feb. 17, 2005

(30) Foreign Application Priority Data
Oct. 18, 2004 (JP) 2004-302615

(51) Int. Cl. G02F 1/1335

(52) U.S. Cl. 349/5

(57) ABSTRACT

An image display apparatus using liquid crystal is provided that offers high contrast and that excels in versatility. The image display apparatus has a liquid crystal layer for displaying an image that is held between a pair of transparent substrates, an illumination portion that feeds the liquid crystal layer with illumination light, a polarizing plate that serves as a polarizer that turns the light from the illumination portion into a linearly polarized light, a polarizing plate that serves as an analyzer that transmits only the linearly polarized light that emerges from the liquid crystal layer when no voltage is applied, and a birefringent film. The birefringent film produces in the light transmitted therethrough a phase difference that varies in the direction of the thickness thereof, and produces the phase difference in such a direction as to cancel the phase difference produced by the liquid crystal layer in the light emerging therefrom when a voltage is applied. This ensures that the light from those pixels of the liquid crystal layer which are not involved in image display at the moment, which light should thus be intercepted, is securely intercepted, resulting in higher contrast in the image presented.

This nonprovisional application claims priority under 35 U.S.C. § 119(a) on Patent Application No. 2004-302615 filed in Japan on Oct. 18, 2004, the entire contents of which are hereby incorporated by reference.

### BACKGROUND OF THE INVENTION

1. Field of the Invention

The present invention relates to an image display apparatus using liquid crystal, and more particularly to improving the contrast of the image produced thereby.

2. Description of Related Art

Image display apparatuses using liquid crystal have been becoming remarkably widespread. Generally, in an image display apparatus using liquid crystal, the part thereof relevant to image display includes the following components: a light source that emits unpolarized illumination light; a first polarizing plate that transmits, of the illumination light from the light source, only linearly polarized light polarized in a predetermined direction; a liquid crystal layer that is held between a pair of transparent substrates and of which the molecules change the orientation thereof according to the magnitude of the voltage applied thereto in such a way as to vary the polarization state of the linearly polarized light that passes through the liquid crystal layer; and a second polarizing plate that transmits only linearly polarized light polarized in a predetermined direction that exits from the liquid crystal layer. Due to the functions that they serve, the first and second polarizing plates are also called a polarizer and an analyzer, respectively.

On the liquid crystal layer side surfaces of the transparent substrates that hold the liquid crystal layer, alignment films are laid, one on each surface, in such a way as to align the liquid crystal molecules in mutually perpendicular directions. When no voltage is applied, the liquid crystal molecules are aligned parallel to the substrates, and are increasingly twisted from one alignment film to the other. In this state, the polarization direction of the linearly polarized light that passes through the liquid crystal layer rotates according to the twist of the molecule alignment. For example, with TN mode liquid crystal, the polarization direction of the linearly polarized light is rotated through 90°. When a voltage is applied, the liquid crystal molecules become inclined relative to the transparent substrates, reducing the amount of light that is transmitted through the analyzer. When as high a voltage as can be used to achieve display is applied, the liquid crystal molecules are aligned perpendicularly to the transparent substrates. In this state, the polarization state of the linearly polarized light that passes through the liquid crystal layer is not changed. Thus, the analyzer absorbs almost all the light, producing no image.

Image display apparatuses using liquid crystal are classified into transmissive and reflective types. In a transmissive image display apparatus, a liquid crystal layer is arranged between a first polarizing plate (polarizer) and a second polarizing plate (analyzer). For further slimming-down, it is also commonly practiced to arrange a light source at a side of the first polarizing plate, in which case a light guide plate is additionally used that directs the illumination light to the first polarizing plate. In a reflective image display apparatus, a reflecting plate is used, and a first polarizing plate (polarizer) is shared as a second polarizing plate (analyzer). Here, a liquid crystal layer can be arranged between the first polarizing plate and the reflecting plate.

A transmissive image display apparatus permits an image to be observed from in front, with illumination light directed to the liquid crystal layer from the direction perpendicular thereto, and also permits an image to be observed from an oblique direction, with illumination light directed to the liquid crystal layer from an oblique direction. A reflective image display apparatus requires that the optical path of illumination light be separated from that of the light that represents an image. Thus, when illumination light is directed to the liquid crystal layer from the direction perpendicular thereto, it is necessary to use a member for optical path separation. To avoid this, illumination light is sometimes directed to the liquid crystal layer from an oblique direction, in which case an image is observed from an oblique direction.

Due to properties inherent in liquid crystal, observing an image from an oblique direction tends to result in lower contrast. To overcome this, there have conventionally been made some proposals.

For example, according to Japanese Patent Application Laid-Open No. H6-43446, illumination light is made incident on a liquid crystal layer perpendicularly thereto, and a refractive member such as a lens array or prism array is arranged on the exit surface side of a second polarizing plate so as to deflect the travel direction of the light representing an image. According to Japanese Patent Application Laid-Open No. H5-346579, illumination light is made obliquely incident on a liquid crystal layer, and a color filter substrate is arranged in a deviated position. According to Japanese Patent Application Laid-Open No. H7-72449, an optical system is so designed that an image is observed by using, of the light that represents the image, the portion that travels in a direction in which high contrast is obtained.

The conventional techniques mentioned above, however, have the following disadvantages. The technique proposed in Japanese Patent Application Laid-Open No. H6-43446 requires the use of a refractive member such as a lens array, and in addition requires that the refractive member be arranged accurately. Even if the refractive member is arranged accurately, this technique suffers from insufficient brightness between the individual lenses or the like that form the array. The technique proposed in Japanese Patent Application Laid-Open No. H5-346579 requires that the color filter substrate be arranged accurately, and in addition suffers from a low pixel aperture ratio, causing the produced image to appear dim. Moreover, this technique is liable to suffer from crosstalk. The technique proposed in Japanese Patent Application Laid-Open No. H7-72449 requires that the arrangement of all the optical members be determined relative to the liquid crystal layer. This reduces flexibility in the design of the apparatus as a whole, and makes it difficult to obtain satisfactory optical performance. Moreover, this technique cannot cope with various optical systems, and thus lacks in versatility.

The reason that making illumination light obliquely incident on a liquid crystal layer results in low contrast is as follows. When all the liquid crystal molecules are aligned perpendicularly to the transparent substrates, near the alignment films, a slight twist remains in the molecule alignment. Moreover, the slight twist remaining in the molecule alignment causes the polarization direction of the linearly polarized light to rotate slightly. This produces a phase difference in the light.

For example, in a case where TN mode liquid crystal is used, the directions of a first and a second polarizing plate (a polarizer and an analyzer, respectively) are made 90° apart from each other so that the light from pixels to which the maximum voltage is applied is intercepted by the second polarizing plate. Even when the maximum voltage is applied, however, the slight twist that remains in the molecule alignment near the alignment films produces a phase difference, which turns part of the light into linearly polarized light that is transmitted through the second polarizing plate. This brings slight brightness in those pixels that are irrelevant to the image being produced, leading to lower contrast. None of the publications cited above makes mention of the causes for such lowering of contrast or how to eliminate or alleviate it.

Incidentally, unless illumination light is a parallel beam, even when the principal ray of the beam is made perpendicularly incident on a liquid crystal layer, the rays in a peripheral portion of the beam are obliquely incident on the liquid crystal layer. Thus, for the same reason as stated above, lowering of contrast does occur.

### SUMMARY OF THE INVENTION

In view of the conventionally encountered problems discussed above, it is an object of the present invention to provide an image display apparatus using liquid crystal that offers high contrast and that excels in versatility.

To achieve the above object, according to one aspect of the present invention, an image display apparatus is provided with: an illumination portion that emits illumination light; a polarizer that transmits, of the illumination light emitted from the illumination portion, only linearly polarized light polarized in a predetermined polarization direction; a liquid crystal layer that is held between a pair of transparent substrates and that turns the linearly polarized light transmitted through the polarizer into light polarized differently according to the magnitude of the voltage applied to the liquid crystal layer; an analyzer that transmits, of the light emerging from the liquid crystal layer, linearly polarized light polarized in a predetermined polarization direction; a projection optical system that projects the linearly polarized light transmitted through the analyzer; and a phase difference producing member that produces in the linearly polarized light traveling from the polarizer through the liquid crystal layer to the analyzer a phase difference in such a direction as to cancel the phase difference produced by the liquid crystal layer according to the angle of incidence.

In this image display apparatus, the phase difference that is produced in the linearly polarized light by the liquid crystal layer can be cancelled by the phase difference producing member. This makes it possible to eliminate or minimize the change in the polarization state of the linearly polarized light as observed when no image is being displayed. Thus, it is possible to prevent the light that should be intercepted by the analyzer from being transmitted therethrough. In this way, it is possible to obtain higher contrast in the presented image.

Here, the projection optical system may be non-axisymmetric. Designing the projection optical system to be non-axisymmetric increases flexibility in the arrangement of the projection optical system and the illumination portion relative to the liquid crystal layer. This makes it possible not only to obtain high contrast but also to minimize various aberrations in the presented image.

The liquid crystal layer may be formed of TN mode liquid crystal. TN mode liquid crystal is a material that is inexpensive and is easy to align, and hence using it makes it possible to produce the image display apparatus at low cost.

The phase difference producing member may be a phase difference film having birefringence such that the phase difference that the phase difference producing member produces in light varies in the direction of thickness thereof. With such a phase difference film, the phase difference it produces in light varies according to the angle of incidence of the light. This makes it possible to deviate the direction in which the maximum contrast is obtained in the presented image from the direction perpendicular to the liquid crystal layer. This increases flexibility in the arrangement of the projection optical system.

The direction of the principal refractive index of the refractive index ellipsoid of the phase difference film may be inclined relative to the direction perpendicular to the phase difference film. With the direction of the principal refractive index of the phase difference film inclined in this way, the phase difference that varies according to the angle of incidence exhibits a non-axisymmetric pattern with respect to the direction perpendicular to the substrates. This makes it possible to more freely determine the direction in which the maximum contrast is obtained in the presented image, and thus to obtain higher contrast in the presented image according to the position of the projection optical system.

The direction of the principal refractive index of the liquid crystal layer as observed when no image is being displayed may be inclined relative to the direction perpendicular to the transparent substrates. Designed in this way, the liquid crystal layer changes the state thereof quickly according to the voltage applied thereto. This makes it possible to switch between the displaying and non-displaying states quickly, and thereby to present images not only with high contrast but with less flicker, permitting the images to change smoothly.

In the design where a phase difference film is used of which the direction of the principal refractive index is inclined or where a liquid crystal layer is used of which the direction of the principal refractive index as observed when no image is being displayed is inclined, the angle between the polarization direction of the linearly polarized light transmitted through the polarizer and the component, parallel to the transparent substrates, of the direction of the principal refractive index of the refractive index ellipsoid of the phase difference film may be larger than 0° but smaller than 90°. With this design, it is possible to efficiently cancel the phase difference produced in the linearly polarized light by the liquid crystal layer. In particular, when the angle mentioned above is made equal to 45°, it is possible to cancel the phase difference with the highest efficiency, and thereby to efficiently obtain higher contrast.

The projection optical system may project the linearly polarized light emerging from the analyzer into the user's eye to present a virtual image of an image. With this design, it is possible to realize an image display apparatus for personal use.

To achieve the above object, according to another aspect of the present invention, an image display apparatus is provided with: an illumination portion that emits illumination light; a polarizer that transmits, of the illumination light emitted from the illumination portion, only linearly polarized light polarized in a predetermined polarization direction; a TN mode liquid crystal layer that is held between a pair of transparent substrates and that turns the linearly polarized light transmitted through the polarizer into light polarized differently according to the magnitude of the voltage applied to the liquid crystal layer; and a phase difference producing member that has birefringence such that the phase difference that the phase difference producing member produces in light varies in the direction of the thickness thereof and that produces in the linearly polarized light traveling from the polarizer through the liquid crystal layer to the analyzer a phase difference in such a direction as to cancel the phase difference produced by the liquid crystal layer according to the angle of incidence. Here, the direction of the principal refractive index of the refractive index ellipsoid of the phase difference producing member is inclined relative to the direction perpendicular to the transparent substrates. Moreover, the angle between the polarization direction of the linearly polarized light transmitted through the polarizer and the component, parallel to the transparent substrates, of the direction of the principal refractive index of the refractive index ellipsoid of the phase difference producing member is larger than 0° but smaller than 90°.

With this image display apparatus, it is possible, as described above, to efficiently cancel the phase difference produced in the linearly polarized light by the liquid crystal layer and thereby to prevent the light that should be intercepted by the analyzer when a voltage is being applied to the liquid crystal layer from being transmitted through the analyzer. This makes it possible to present images with high contrast. In particular, when the angle mentioned above is made equal to 45°, it is possible to cancel the phase difference with the highest efficiency, and thereby to efficiently obtain higher contrast.

### BRIEF DESCRIPTION OF THE DRAWINGS

FIG. 1 is a sectional view schematically showing the optical construction of the image display apparatus of a first embodiment of the invention;

FIG. 2 is a perspective view schematically showing the construction of the display portion of the image display apparatus of the first embodiment;

FIG. 3A is a diagram schematically showing the relationship between the angle of incidence and the phase difference produced by the birefringent film as observed in the image display apparatus of the first embodiment;

FIG. 3B is a diagram schematically showing the relationship between the angle of incidence and the phase difference produced by the liquid crystal layer as observed in the image display apparatus of the first embodiment;

FIG. 3C is a diagram schematically showing the relationship between the angle of incidence and the contrast obtained in the presented image as observed in the image display apparatus of the first embodiment;

FIG. 4 is a sectional view schematically showing the optical construction of the image display apparatus of a second embodiment of the invention;

FIG. 5 is a perspective view schematically showing the construction of the display portion of the image display apparatus of the second embodiment;

FIG. 6 is a diagram schematically showing how the birefringence produced in light by the liquid crystal layer is canceled by the birefringence film in the image display apparatus of the second embodiment;

FIG. 7 is a diagram schematically showing the relationship between the angle of incidence and the contrast obtained in the presented image as observed in the image display apparatus of the second embodiment;

FIG. 8 is a sectional view schematically showing the optical construction of the image display apparatus of a third embodiment of the invention;

FIG. 9 is a perspective view schematically showing the construction of the display portion of the image display apparatus of the third embodiment;

FIG. 10A is a diagram schematically showing the relationship between the angle of incidence and the phase difference produced by the birefringent film as observed in the image display apparatus of the third embodiment;

FIG. 10B is a diagram schematically showing the relationship between the angle of incidence and the phase difference produced by the liquid crystal layer as observed in the image display apparatus of the third embodiment;

FIG. 10C is a diagram schematically showing the relationship between the angle of incidence and the contrast obtained in the presented image as observed in the image display apparatus of the third embodiment;

FIG. 11 is a sectional view schematically showing the optical construction of the image display apparatus of a fourth embodiment of the invention;

FIG. 12 is a perspective view schematically showing the construction of the display portion of the image display apparatus of the fourth embodiment;

FIG. 13A is a diagram schematically showing the relationship between the angle of incidence and the phase difference produced by the birefringent film as observed in the image display apparatus of the fourth embodiment;

FIG. 13B is a diagram schematically showing the relationship between the angle of incidence and the phase difference produced by the liquid crystal layer as observed in the image display apparatus of the fourth embodiment;

FIG. 13C is a diagram schematically showing the relationship between the angle of incidence and the contrast obtained in the presented image as observed in the image display apparatus of the fourth embodiment;

FIG. 14 is a sectional view schematically showing the optical construction of the image display apparatus of a fifth embodiment of the invention;

FIG. 15 is a perspective view schematically showing the construction of the display portion of the image display apparatus of the fifth embodiment;

FIG. 16A is a diagram schematically showing the relationship between the angle of incidence and the phase difference produced by the birefringent film as observed in the image display apparatus of the fifth embodiment;

FIG. 16B is a diagram schematically showing the relationship between the angle of incidence and the phase difference produced by the liquid crystal layer as observed in the image display apparatus of the fifth embodiment;

FIG. 16C is a diagram schematically showing the relationship between the angle of incidence and the contrast obtained in the presented image as observed in the image display apparatus of the fifth embodiment;

FIG. 17 is a perspective view schematically showing the construction of the display portion of the image display apparatus of a sixth embodiment of the invention;

FIGS. 18A to 18C are a front view, a top view, and a side view, respectively, schematically showing the exterior appearance of the image display apparatus of a seventh embodiment of the invention;

FIGS. 19A to 19C are a front view, a top view, and a side view, respectively, schematically showing the exterior appearance of the image display apparatus of an eighth embodiment of the invention; and

FIG. 20 is a sectional view schematically showing the optical construction of the image display apparatus of a ninth embodiment of the invention.

### DETAILED DESCRIPTION OF PREFERRED EMBODIMENTS

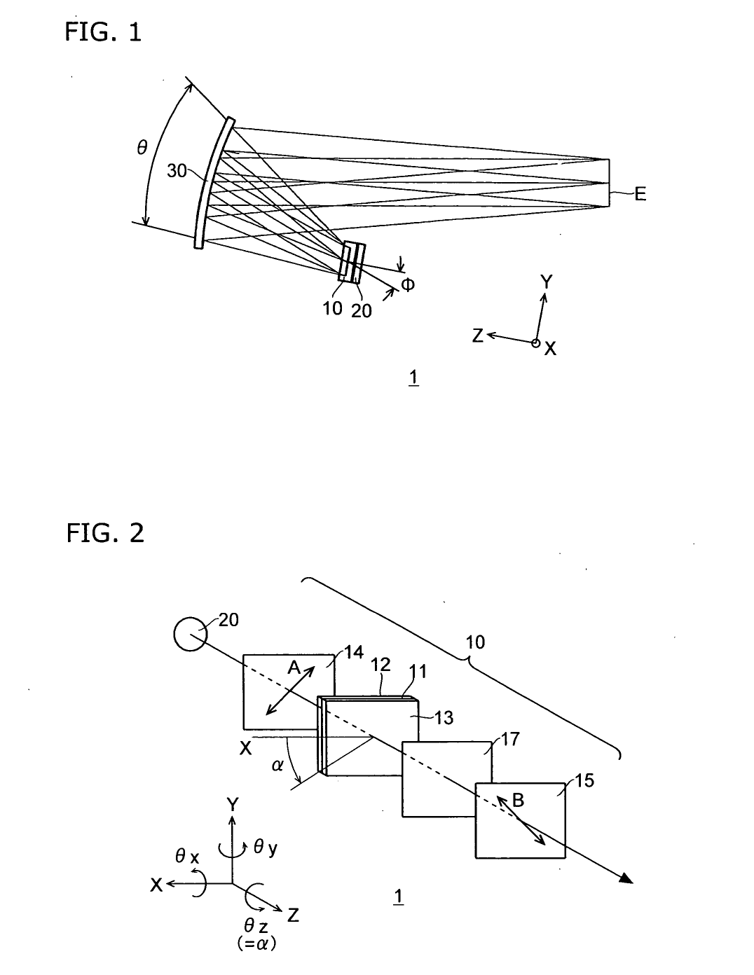

Hereinafter, embodiments of the present invention will be described with reference to the accompanying drawings. The optical construction of the image display apparatus 1 of a first embodiment of the invention is schematically shown in FIG. 1. The image display apparatus 1 includes: a display portion 10 including a transmissive liquid crystal layer 11 (see FIG. 2); an illumination portion 20 that feeds the liquid crystal layer 11 with illumination light; and a projection optical system 30 that presents an image by projecting the light representing the image that emerges from the display portion 10.

The illumination portion 20 is composed of a light source (not illustrated) that emits unpolarized light and a light guide plate that directs the light emitted from the light source to the liquid crystal layer 11 of the display portion 10. The projection optical system 30 is composed of a concave-surface mirror, and reflects and thereby directs the light from the display portion 10 to the optical pupil E so that an enlarged virtual image of the image displayed on the display portion 10 can be observed at the position of the optical pupil E. The distance from the optical pupil E to the virtual image is about several meters, and the size of the virtual image is ten or more times as large as that of the image displayed on the display portion 10.

The illumination portion 20 and the display portion 10 are so designed that the illumination light is obliquely incident on the liquid crystal layer 11, and the concave-surface mirror used as the projection optical system 30 is given a non-axisymmetric free-form surface. The illumination light emitted from the illumination portion 20 is a divergent beam, and the light that emerges from each pixel in the liquid crystal layer 11 is a divergent beam. In the following descriptions, the angle between the principal ray of the illumination light (i.e., the ray that is incident on the center of the liquid crystal layer 11 and that corresponds to the center of the image) and the normal to the liquid crystal layer 11 is represented by Φ, and the angular width of the illumination light that illuminates the entire liquid crystal layer 11 is represented by θ. That is, the angle of incidence of the illumination light with respect to the liquid crystal layer 11 has an angular width of θ around an angle of Φ, and the angle of emergence from the liquid crystal layer 11 also has an angular width of θ around an angle of Φ.

The construction of the display portion 10 is schematically shown in FIG. 2. The display portion 10 includes: the liquid crystal layer 11; a pair of transparent substrates 12 and 13 between which the liquid crystal layer 11 is held; a first polarizing plate 14; a second polarizing plate 15; and a birefringent film 17. These are all arranged parallel to one another.

In the following descriptions, as shown in FIG. 2, the direction horizontal and parallel to the liquid crystal layer 11 is referred to as the X direction, the direction perpendicular to the X direction and parallel to the liquid crystal layer 11 is referred to as the Y direction, and the direction perpendicular to the liquid crystal layer 11 is referred to as the Z direction. The “X”, “Y”, and “Z” shown in FIG. 1 indicate these directions. Angles around the X, Y, and Z axes are expressed as θx, θy, and θz. Angles θx and θy are measured relative to the Z direction (which is assumed to be 0°), and an angle θz is measured relative to the X direction. An angle within the plane of the liquid crystal layer 11 is expressed specially as a direction angle α (=θz), with the positive X direction assumed to be α=0°. In FIG. 1, the principal ray of the illumination light is inclined only in the Y direction with respect to the liquid crystal layer 11, and the angle of incidence thereof is expressed as θx, where θx=Φ. The angle of incidence of the illumination light with respect to the liquid crystal layer 11 has a width of θ in the Y direction.

In FIG. 2, the individual members constituting the display portion 10 are illustrated with ample spacing among them. It is, however, also possible to arrange these members in contact with one another. This applies also to the other embodiments that will be described later.

The transparent substrates 12 and 13, between which the liquid crystal layer 11 is held, are arranged between the first polarizing plate 14 and the second polarizing plate 15. The transparent substrates 12 and 13 are provided respectively with transparent electrodes (not illustrated) via which a voltage is applied to the liquid crystal layer 11. On the liquid crystal layer side surfaces of the transparent substrates 12 and 13, alignment films (not shown) are respectively laid for aligning the liquid crystal molecules. In the image display apparatus 1, the liquid crystal layer 11 is formed of TN mode liquid crystal, and the liquid crystal molecules are so aligned as to be parallel to the transparent substrates 12 and 13 and 90° twisted from the transparent substrate 12 to the transparent substrate 13.

The first polarizing plate 14 transmits, of the unpolarized illumination light emitted from the illumination portion 20, only linearly polarized light polarized in a predetermined direction to direct this light to the liquid crystal layer 11. The first polarizing plate 14 thus functions as a polarizer. The polarization direction of the linearly polarized light that is transmitted through the first polarizing plate 14 is indicated by arrow A. The direction angle α of the polarization direction A of the linearly polarized light that is transmitted through the first polarizing plate 14 is 45°. The alignment film laid on the transparent substrate 12 is so designed as to align the molecules of the liquid crystal layer 11 perpendicularly to the direction A. Thus, the linearly polarized light emerging from the first polarizing plate 14 enters the liquid crystal layer 11 without being intercepted near the transparent substrate 12 of the liquid crystal layer 11.

The second polarizing plate 15 is designed to transmit only linearly polarized light polarized in the direction perpendicular to the polarization direction of the linearly polarized light transmitted through the first polarizing plate 14. The second polarizing plate 15 thus functions as an analyzer. The polarization direction of the linearly polarized light that is transmitted through the second polarizing plate 15 is indicated by arrow B. The direction angle α of the polarization direction B of the linearly polarized light that is transmitted through the second polarizing plate 15 is −45°.

Designed as described above, the image display apparatus 1 operates as follows. When no voltage is applied to the liquid crystal layer 11, it turns through 90° the polarization direction of the linearly polarized light that passes therethrough, and the second polarizing plate 15 transmits the linearly polarized light that has the polarization direction thereof so turned. As the magnitude of the voltage applied increases, the direction of the principal refractive index of the liquid crystal layer 11 becomes increasingly inclined relative to the state parallel to the transparent substrates 12 and 13, accordingly reducing the light transmitted through the second polarizing plate (analyzer) 15. Thus, any pixels to which the maximum voltage for display is applied are brought into a non-displaying state (i.e., the state in which they appear black).

In the non-displaying state, in which the maximum voltage for display is applied, most of the liquid crystal molecules of the liquid crystal layer 11 align in the direction perpendicular to the transparent substrates 12 and 13, but, near the alignment films, a slight twist remains in the alignment of the liquid crystal molecules. This twist causes the polarization direction of the linearly polarized light to rotate slightly according to the angle of incidence, and thereby produces a phase difference in the light. This happens when the linearly polarized light that is transmitted through the second polarizing plate 15 is produced. As a result, pixels in the non-displaying state appear slightly bright, lowering the overall contrast according to the angle of incidence.

The birefringent film 17 is provided to eliminate the cause of the above-mentioned lowering of contrast according to the angle of incidence. The birefringent film 17 is arranged between the transparent substrate 13 and the second polarizing plate 15. The birefringent film 17 is so designed that the phase difference it produces in the light passing therethrough varies in the direction of the thickness thereof. The birefringent film 17 produces in the light emerging from the liquid crystal layer 11 a phase difference in such a direction as to cancel the phase difference produced by the liquid crystal layer 11.

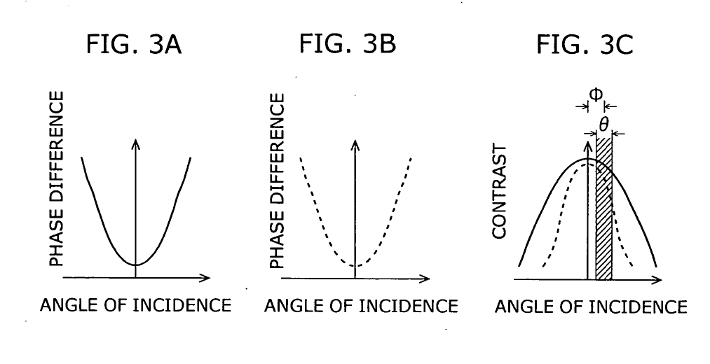

FIG. 3A schematically shows the relationship between the angle of incidence of the light incident on the birefringent film 17 and the phase difference produced by the birefringent film 17 in the light passing therethrough. The angle of incidence is expressed as θx as observed when θy=0°. The birefringent film 17 acts in such a way as to advance the phase of the incident light in the direction parallel to the plane of incidence relative to the phase of the same light in the direction perpendicular to the plane of incidence. Moreover, the birefringent film 17 is isotropic in the direction parallel to the birefringent film 17, and thus, in this direction, it produces an equal phase difference in light of any direction angle α so long as the angle of incidence is equal. Moreover, the birefringent film 17 produces a slight phase difference even at an angle of incidence θx of 0°.

FIG. 3B shows the relationship between the angle of incidence of the light incident on the liquid crystal layer 11 and the phase difference produced by the liquid crystal layer 11 in the light passing therethrough as observed when the maximum voltage is applied to the liquid crystal layer 11, i.e., when it is in the non-displaying state. The angle of incidence is expressed as θx as observed when θy=0°. The reason that the phase difference is represented with a broken line in FIG. 3B is that it has the opposite sign (indicating whether it is positive or negative) relative to that shown in FIG. 3A. That is, the liquid crystal layer 11 delays the phase in the direction parallel to the plane of incidence relative to the phase in the direction perpendicular to the plane of incidence.

FIG. 3C shows the relationship between the angle of incidence of the light incident on the liquid crystal layer 11 and the contrast obtained in the presented image. The angle of incidence is expressed as θx, and the contrast plotted assumes that θy=0°. In FIG. 3C, the solid line represents the contrast obtained when the birefringent film 17 is provided, and, for comparison, the broken line represents the contrast obtained when the birefringent film 17 is removed. In the image display apparatus 1, an image is presented by the use of light of which the center of the angle of incidence with respect to the liquid crystal layer 11 is Φ and of which the angular width is θ. FIG. 3C shows that the provision of the birefringent film 17 contributes to higher contrast in the image produced by that light.

In the TN mode liquid crystal shown in FIG. 2, the dependence of the phase difference on the angle of incidence is smaller in the X direction, in which the angle of incidence is expressed as θy, than in the Y direction, in which the angle of incidence is expressed as θx. Thus, the birefringent film 17 increases the dependence of the phase difference on the angle of incidence in the X direction. However, in the X direction, the light used has angles of incidence around θy=0°, in which range the phase difference is small, and therefore it is still possible to obtain high contrast in the presented image.

Moreover, with a birefringent film that produces in light only a small phase difference in the direction of thickness thereof, for example a film such as a half-wave phase plate, the phase difference within the plane hardly varies between when the angle of incidence of the light is 0° and otherwise. Thus, using a birefringence film that produces only a small phase difference in the direction of the thickness thereof is not effective in increasing the contrast that depends on the angle of incidence.

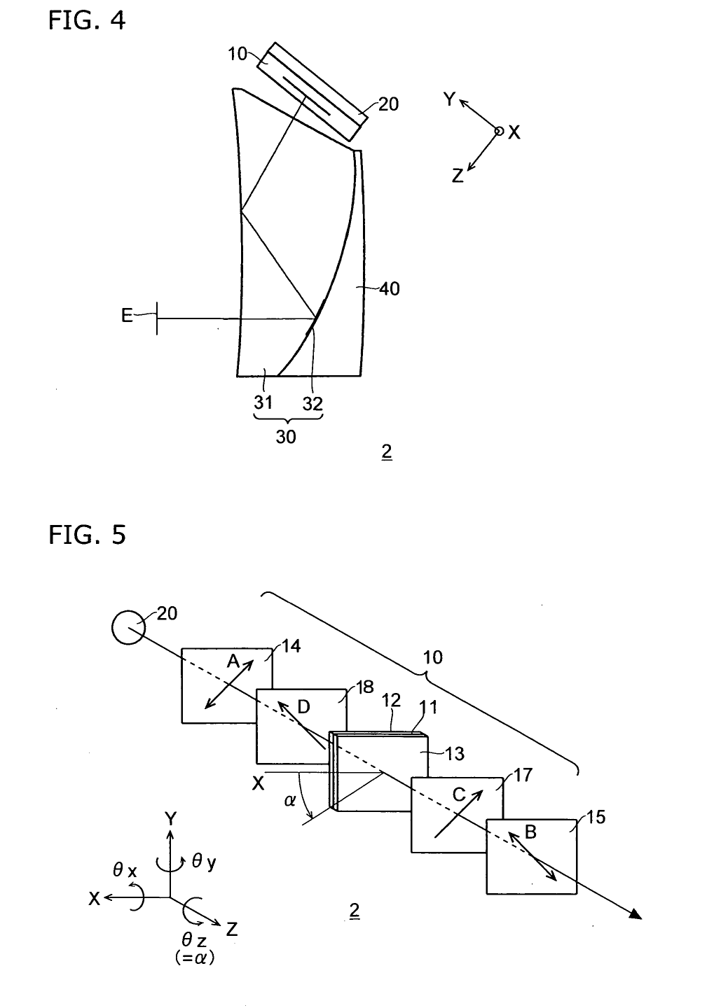

The optical construction of the image display apparatus 2 of a second embodiment of the invention is schematically shown in FIG. 4. The image display apparatus 2 includes: a display portion 10 including a transmissive liquid crystal layer 11 (see FIG. 5); an illumination portion 20 that feeds the liquid crystal layer 11 with illumination light; and a projection optical system 30 that presents an image by projecting the light representing the image that emerges from the display portion 10.

The illumination portion 20 is composed of a light source (not illustrated) that emits unpolarized light and a light guide plate that directs the light emitted from the light source to the liquid crystal layer 11 of the display portion 10. Also in the image display apparatus 2, the illumination light from the illumination portion 20 is incident on the liquid crystal layer 11 at an angle of incidence of which the center is Φ (≠0°) and of which the angular width is θ (≠0°).

The projection optical system 30 is composed of a transparent substrate 31 and a volume phase reflective hologram 32 formed on the surface thereof. The transparent substrate 31 has free-form surfaces on two opposite faces thereof, on one of which is formed the hologram 32.

The light representing an image from the display portion 10 enters the transparent substrate 31 through an end face thereof, is then totally reflected from one face, is then incident on the hologram 32 formed on the opposite face, and is then reflected therefrom. After being reflected from the hologram 32, the light from the display portion 10 exits from the transparent substrate 31 and reaches the optical pupil E. The two free-form surfaces of the transparent substrate are so designed as to be non-axisymmetric and have a positive optical power with respect to the light from the display portion 10. An enlarged virtual image of the image displayed on the display portion 10 can be observed at the position of the optical pupil E. The distance from the optical pupil E to the virtual image is about several meters, and the size of the virtual image is ten or more times as large as that of the image displayed on the display portion 10.

The reflective hologram 32 exhibits high wavelength selectivity, and thus transmits most of the light incoming from the outside world. Moreover, the transparent substrate 31 transmits most of the light incoming from the outside world. Thus, the user can observe the outside world. The virtual image of the image displayed on the display portion 10 is observed superimposed on part of the outside world.

When the light from the outside world is transmitted through the free-form surfaces of the transparent substrate 31, it is refracted. To prevent the outside world from being observed distorted by the refraction there, another transparent substrate 40 is bonded to the face of the transparent substrate 31 on which the volume phase reflective hologram 32 is formed. The transparent substrate 40 has, on the face thereof facing the bonding surface, a free-form surface that agrees in shape with the free-form surface on the face of the transparent substrate 31 facing the bonding surface. After being transmitted through these two free-form surfaces, the light from the outside world proceeds to travel along an optical path parallel to the optical path along which it has been traveling before being transmitted therethrough. These two surfaces may be formed into surfaces parallel to each other, instead of free-form surfaces.

The construction of the display portion 10 is schematically shown in FIG. 5. The display portion 10 here differs from that used in the image display apparatus 1 of the first embodiment in that, for the purpose of canceling the phase difference produced by the liquid crystal layer 11 and thereby obtaining higher contrast in the presented image, it is provided with two birefringent films 17 and 18. The liquid crystal layer 11 is formed of TN mode liquid crystal. The birefringent film 17 is arranged between the transparent substrate 13 and the second polarizing plate (analyzer) 15, and the birefringent film 18 is arranged between the first polarizing plate (polarizer) 14 and the transparent substrate 12.

The birefringent film 17 is so designed that the phase difference it produces in light varies in the direction of the thickness thereof, and in addition that the direction of the principal refractive index of the refractive index ellipsoid thereof is inclined relative to the direction perpendicular to the birefringent film 17. The direction of the component, parallel to the birefringent film 17, of the principal refractive index of the birefringent film 17 is indicated by arrow C. The direction angle α of the component, parallel to the birefringent film 17, of the principal refractive index of the birefringent film 17 is −135°. The direction of arrow C indicates the direction in which the refractive index ellipsoid is inclined.

The birefringent film 18 also is so designed that the phase difference it produces varies in the direction of the thickness thereof, and in addition that the direction of the principal refractive index of the refractive index ellipsoid thereof is inclined relative to the direction perpendicular to the birefringent film 18. The direction of the component, parallel to the birefringent film 18, of the principal refractive index of the birefringent film 18 is indicated by arrow D. The direction angle α of the component, parallel to the birefringent film 18, of the principal refractive index of the birefringent film 18 is −45°. The direction of arrow D indicates the direction in which the refractive index ellipsoid is inclined.

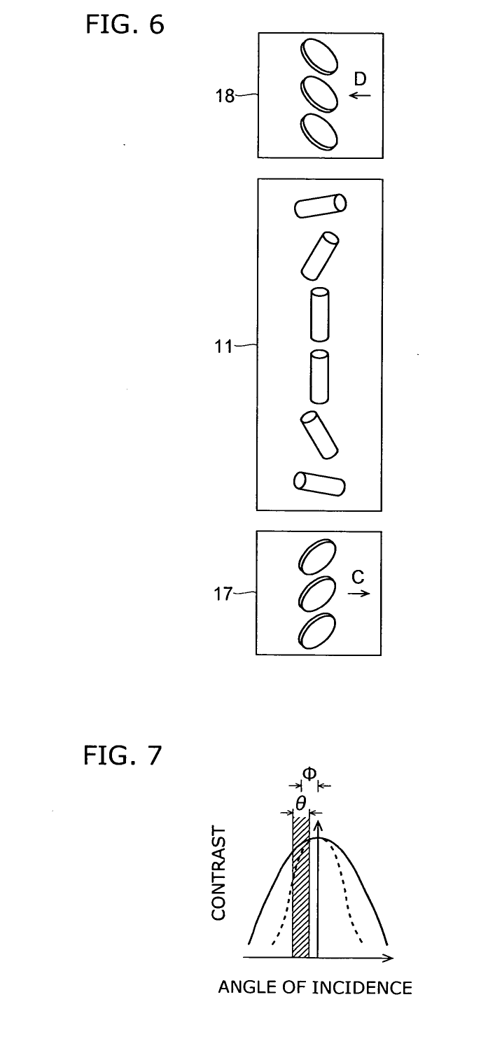

How the birefringence produced in light by the liquid crystal layer 11 when the maximum voltage is applied thereto and thus when it is in the non-displaying state is cancelled by the birefringent films 17 and 18 is schematically shown in FIG. 6. The birefringent film 17 produces, in the light transmitted through the liquid crystal layer 11, birefringence in such a direction as to cancel the birefringence produced near the transparent substrate 13 side alignment film in the liquid crystal layer 11. The birefringent film 18 produces, in the light incident on the liquid crystal layer 11, birefringence in such a direction as to cancel the birefringence produced near the transparent substrate 12 side alignment film in the liquid crystal layer 11.

The relationship between the angle of incidence of the light incident on the liquid crystal layer 11 and the contrast obtained in the present image as observed in the image display apparatus 2 is shown in FIG. 7. The angle of incidence is expressed as θx as observed when θy=0°. In FIG. 7, the solid line represents the contrast obtained when the birefringent films 17 and 18 are provided, and, for comparison, the broken line represents the contrast obtained when the birefringent films 17 and 18 are removed. In the image display apparatus 2, an image is presented by the use of light of which the center of the angle of incidence with respect to the liquid crystal layer 11 is Φ and of which the angular width is θ. FIG. 7 shows that the provision of the birefringent films 17 and 18 makes it possible to eventually cancel the phase difference produced according to the angle of incidence and thereby obtain higher contrast in the image produced by that light.

Since the directions D and C of the components, parallel to the film surface, of the direction of the principal refractive index of the birefringent films 18 and 17 are respectively set to be perpendicular to the polarization directions A and B of the linearly polarized light that is transmitted through the polarizing plates 14 and 15, the phase difference within the plane parallel to the birefringent films 17 and 18 has hardly any effect on the linearly polarized light. On the other hand, in the X direction, in which the angle of incidence is θy, the light used has angles of incidence around θy=0°, in which range the phase difference is small, and therefore it is possible to obtain higher contrast in the presented image.

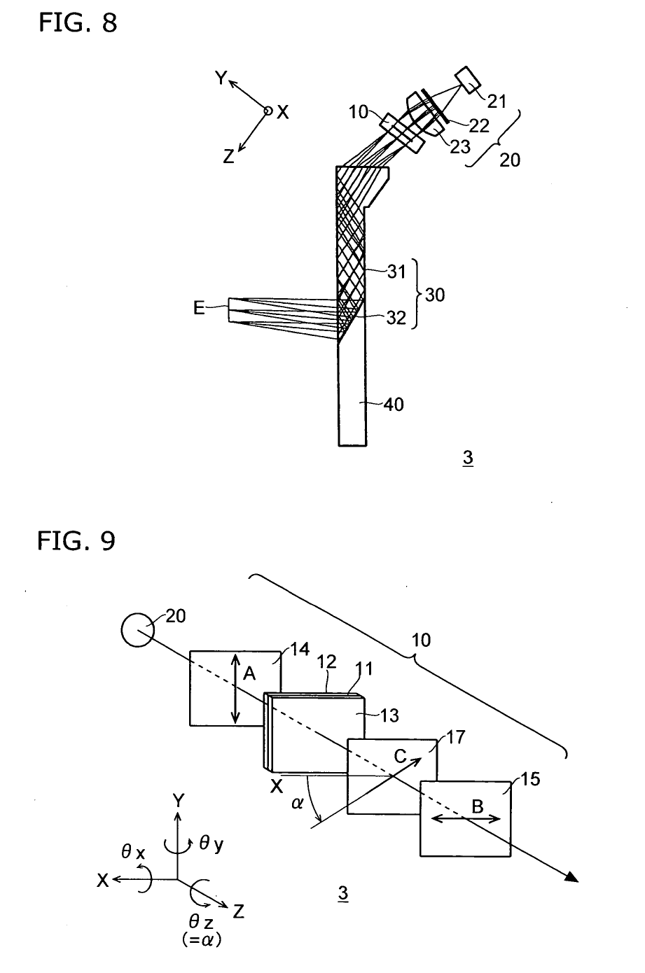

The optical construction of the image display apparatus 3 of a third embodiment of the invention is schematically shown in FIG. 8. The image display apparatus 3 includes: a display portion 10 including a transmissive liquid crystal layer 11 (see FIG. 9); an illumination portion 20 that feeds the liquid crystal layer 11 with illumination light; and a projection optical system 30 that presents an image by projecting the light representing the image that emerges from the display portion 10.

The illumination portion 20 is composed of a light source 21 that emits unpolarized light, a diffuser plate 22 that anisotropically diffuses the illumination light from the light source 21, and a condenser lens 23 that makes the light transmitted through the diffuser plate 22 converge. The image display apparatus 3 is designed to present color images. To achieve this, the light source 21 is built with a hybrid RGB light-emitting diode that emits light in three wavelength bands, namely in wavelength bands of which the center wavelengths are 465 nm, 520 nm, and 635 nm, respectively.

The diffuser plate 22 diffuses the light from the light source 21 about 40° in the right/left direction (the direction perpendicular to the plane of FIG. 8) and about 2° in the direction perpendicular thereto. The condenser lens 23 is so arranged that the light diffused by the diffuser plate 22 efficiently forms the optical pupil E.

Also in the image display apparatus 3, the illumination light from the illumination portion 20 is incident on the liquid crystal layer 11 at an angle of incidence of which the center is Φ (≠0°) and of which the angular width is θ (≠0°).

The projection optical system 30 is composed of a transparent substrate 31 and a volume phase reflective hologram 32. The transparent substrate 31 is, in a bottom-end portion thereof, wedge-shaped with the thickness thereof decreasing toward the bottom end, and, in a top-end portion thereof, so shaped that the thickness thereof increases toward the top end. The hologram 32 is bonded to a inclined surface in the bottom-end portion of the transparent substrate 31. The volume phase reflective hologram 32 is so designed as to diffract light in three wavelength bands, namely the wavelength bands of 465±10 nm, 520±10 nm, and 635±nm.

The light representing an image from the display portion 10 enters the transparent substrate 31 through the top face thereof, is then totally reflected a plurality of times from opposite faces, and is then incident on the volume phase reflective hologram 32. The light incident on the volume phase reflective hologram 32 is reflected therefrom to reach the optical pupil E. The hologram 32 is so designed as to exhibit a non-axisymmetric positive optical power with respect to the light from the display portion 10. An enlarged virtual image of the image displayed on the display portion 10 can be observed at the position of the optical pupil E. The distance from the optical pupil E to the virtual image is about several meters, and the size of the virtual image is ten or more times as large as that of the image displayed on the display portion 10.

The hologram 32 and the transparent substrate 31 transmit most of the light incoming from the outside world. Thus, the user can observe the outside world. The virtual image of the image displayed on the display portion 10 is observed superimposed on part of the outside world.

To prevent distortion from occurring in the outside world observed as a result of the light therefrom being transmitted through the wedge-shaped bottom-end portion of the transparent substrate 31, a transparent substrate 40 is bonded to the inclined surface of the bottom-end portion of the transparent substrate 31 on which the hologram 32 is formed. The transparent substrate 40 and the transparent substrate 31 together form a parallel plate, and this prevents distortion from occurring in the outside world observed.

In the image display apparatus 3, the light from the display portion 10 is directed to the hologram 32 by the total reflection inside the transparent substrate 31. This makes it possible to arrange the illumination portion 20 and the display portion 10 considerably away from immediately in front of the user's eye. This makes it possible to obtain a wide angle of view with respect to the outside world. The transparent substrate 13 can be made as thin as about 3 mm, permitting the image display apparatus 3 to be made compact and lightweight.

The construction of the display portion 10 is schematically shown in FIG. 9. The display portion 10 has a similar construction to that of the image display apparatus 1 of the first embodiment. Here, the direction angle α of the polarization direction A of the linearly polarized light transmitted through the first polarizing plate (polarizer) 14 is 90°, and the direction angle α of the polarization direction B of the linearly polarized light transmitted through the second polarizing plate (analyzer) 15 is 0°. The liquid crystal layer 11 is formed of TN mode liquid crystal.

The birefringent film 17 is so designed that the phase difference it produces in light varies in the direction of the thickness thereof, and in addition that the direction of the principal refractive index of the refractive index ellipsoid thereof is inclined relative to the direction perpendicular to the birefringent film 17. The direction C of the component, parallel to the birefringent film 17, of the principal refractive index has a direction angle α of −150°. Moreover, the direction C of the component, parallel to the birefringent film 17, of the principal refractive index of the birefringent film 17 is neither parallel nor perpendicular to either of the polarization directions A and B of the linearly polarized light transmitted through the first and second polarizing plates 14 and 15. This cancels the phase difference within the plane parallel to the liquid crystal layer 11.

Incidentally, the birefringent film 17 produces hardly any phase difference according to the angle of incidence in the direction (having a direction angle α of 60°) parallel to the birefringent film 17 and perpendicular to the direction C of the above-mentioned component. Thus, the birefringent film 17 does not change contrast in this direction, in which the phase difference produced by the liquid crystal layer 11 is small.

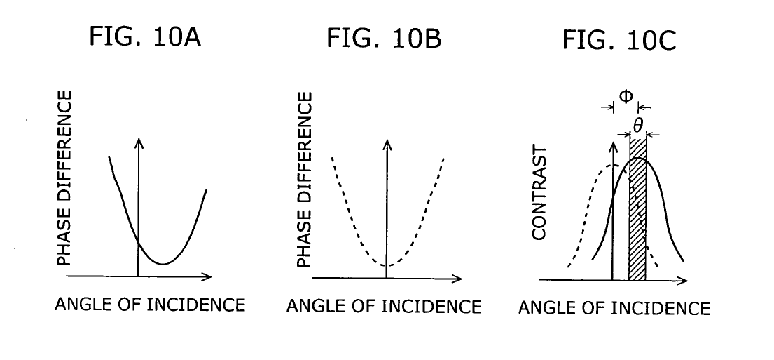

FIG. 10A schematically shows the relationship between the angle of incidence of the light incident on the birefringent film 17 and the phase difference produced by the birefringent film 17 in the light passing therethrough. The angle of incidence is that of the light of which the plane of incidence is perpendicular to the liquid crystal layer 11 and parallel to the above-mentioned direction C. The birefringent film 17 acts in such a way as to advance the phase in the direction parallel to the plane of incidence relative to the phase in the direction perpendicular to the plane of incidence. On the other hand, as described above, the birefringent film 17 produces no phase difference in the direction parallel to the birefringent film 17 and perpendicular to the direction C of the above-mentioned component.

FIG. 10B shows the relationship between the angle of incidence of the light incident on the liquid crystal layer 11 and the phase difference produced by the liquid crystal layer 11 in the light passing therethrough as observed when the maximum voltage is applied to the liquid crystal layer 11, i.e., when it is in the non-displaying state. The angle of incidence is that of the light of which the plane of incidence is perpendicular to the liquid crystal layer 11 and parallel to the above-mentioned direction C. The reason that the phase difference is represented with a broken line in FIG. 10B is that it has the opposite sign (indicating whether it is positive or negative) relative to that shown in FIG. 10A. That is, the liquid crystal layer 11 delays the phase in the direction parallel to the plane of incidence relative to the phase in the direction perpendicular to the plane of incidence.

FIG. 10C shows the relationship between the angle of incidence of the light incident on the liquid crystal layer 11 and the contrast obtained in the presented image. The angle of incidence is expressed as θx as observed when θy=0°. In FIG. 10C, the solid line represents the contrast obtained when the birefringent film 17 is provided, and, for comparison, the broken line represents the contrast obtained when the birefringent film 17 is removed. In the image display apparatus 3, an image is presented by the use of light of which the center of the angle of incidence with respect to the liquid crystal layer 11 is Φ and of which the angular width is θ. FIG. 10C shows that the provision of the birefringent film 17 contributes to higher contrast in the image produced by that light.

In the image display apparatus 3, since the phase difference produced by the liquid crystal layer 11 in the incident light of which the plane of incidence is perpendicular to the direction C (having a direction angle α of 30°) is small, this phase difference is not canceled. By contrast, since the phase difference produced by the liquid crystal layer 11 in the incident light of which the plane of incidence is perpendicular to the liquid crystal layer 11 and parallel to the direction C is large, this phase difference is canceled. As a result, it is possible to present an image with high contrast as a whole.

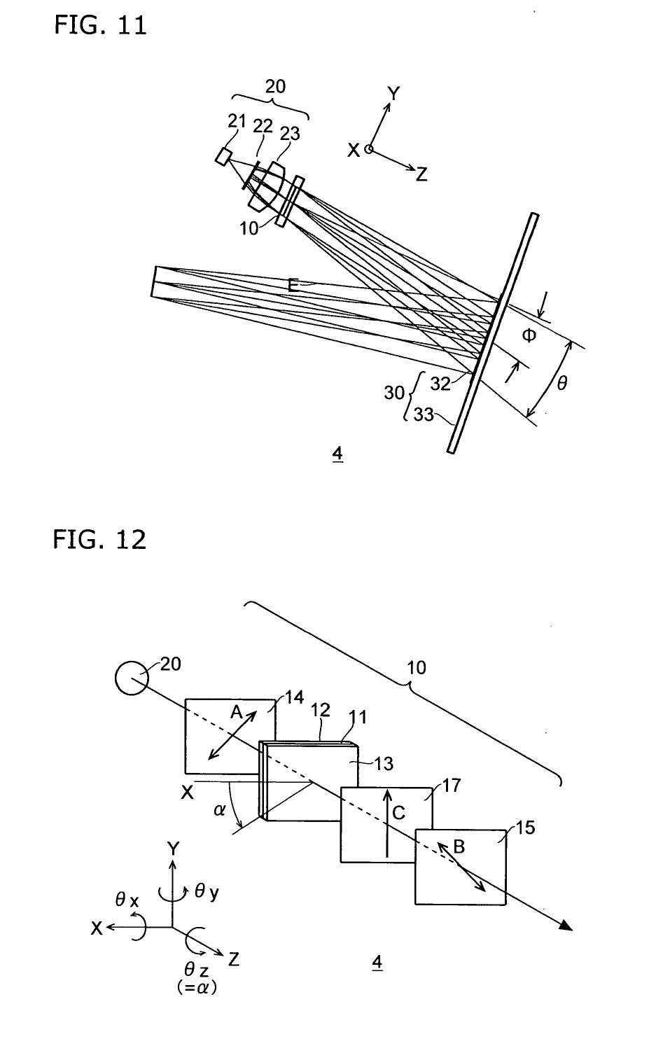

The optical construction of the image display apparatus 4 of a fourth embodiment of the invention is schematically shown in FIG. 11. The image display apparatus 4 includes: a display portion 10 including a transmissive liquid crystal layer 11 (see FIG. 12); an illumination portion 20 that feeds the liquid crystal layer 11 with illumination light; and a projection optical system 30 that presents an image by projecting the light representing the image that emerges from the display portion 10.

The illumination portion 20 is composed of a light source 21 that emits unpolarized light, a diffuser plate 22 that anisotropically diffuses the illumination light from the light source 21, and a condenser lens 23 that makes the light transmitted through the diffuser plate 22 converge. The light source 21 is built with a light-emitting diode that emits light in a wavelength band of which the center wavelength is 550 nm. The diffuser plate 22 diffuses the light from the light source 21 about 40° in the right/left direction (the direction perpendicular to the plane of FIG. 11) and about 2° in the direction perpendicular thereto. The condenser lens 23 is so arranged that the light diffused by the diffuser plate 22 efficiently forms the optical pupil E.

Also in the image display apparatus 4, the illumination light from the illumination portion 20 is incident on the liquid crystal layer 11 at an angle of incidence of which the center is Φ (≠0°) and of which the angular width is θ (≠0°).

The projection optical system 30 is composed of a volume phase reflective hologram 32 and a transparent substrate 33 that holds it. The hologram 32 is so designed as to diffract light in the wavelength range of 550±10 nm. Moreover, the hologram 32 is so designed as to exhibit a non-axisymmetric positive optical power with respect to the light from the display portion 10. An enlarged virtual image of the image displayed on the display portion 10 can be observed at the position of the optical pupil E. The distance from the optical pupil E to the virtual image is about several meters, and the size of the virtual image is ten or more times as large as that of the image displayed on the display portion 10.

The hologram 32 and the transparent substrate 33 transmit most of the light incoming from the outside world. Thus, the user can observe the outside world. The virtual image of the image displayed on the display portion 10 is observed superimposed on part of the outside world.

The construction of the display portion 10 is schematically shown in FIG. 12. The display portion 10 has a similar construction to the image display apparatus 1 of the first embodiment, but differs therefrom in that, not only does the phase difference the birefringent film 17 produces in light vary in the direction of the thickness thereof, but the direction of the principal refractive index of the refractive index ellipsoid thereof is inclined relative to the direction perpendicular to the birefringent film 17. The liquid crystal layer 11 is formed of TN mode liquid crystal. The direction C of the component, parallel to the birefringent film 17, of the principal refractive index of the birefringent film 17 has a direction angle α of −90°, and forms angles of 45° with the polarization directions A and B of the linearly polarized light transmitted through the first and second polarizing plates 14 and 15.

The birefringent film 17 cancels the phase difference produced by the liquid crystal layer 11 in the Y-direction incident light of which the angle of incidence is θx. Incidentally, the birefringent film 17 produces hardly any phase difference in the X-direction incident light of which the angle of incidence is θy, and thus does not change contrast in this direction, in which the phase difference produced by the liquid crystal layer 11 is small.

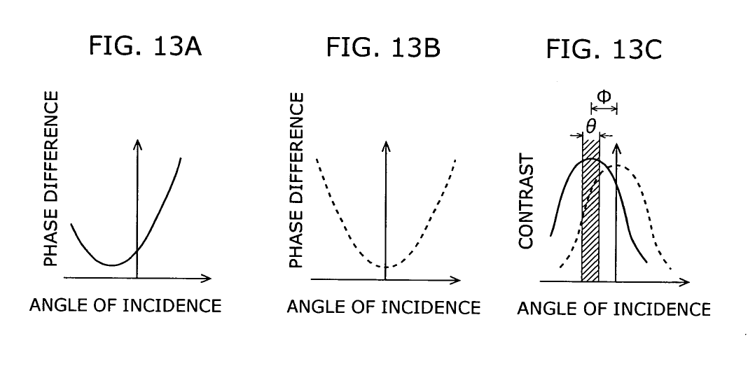

FIG. 13A schematically shows the relationship between the angle of incidence of the light incident on the birefringent film 17 and the phase difference produced by the birefringent film 17 in the light passing therethrough. The angle of incidence is expressed as θx as observed when θy=0°. The birefringent film 17 acts in such a way as to advance the phase of the incident light in the direction parallel to the plane of incidence relative to the phase of the same light in the direction perpendicular to the plane of incidence. On the other hand, as described above, the birefringent film 17 produces no phase difference in the X direction.

FIG. 13B shows the relationship between the angle of incidence of the light incident on the liquid crystal layer 11 and the phase difference produced by the liquid crystal layer 11 in the light passing therethrough as observed when the maximum voltage is applied to the liquid crystal layer 11, i.e., when it is in the non-displaying state. The angle of incidence is expressed as θx as observed when θy=0°. The reason that the phase difference is represented with a broken line in FIG. 13B is that it has the opposite sign (indicating whether it is positive or negative) relative to that shown in FIG. 13A. That is, the liquid crystal layer 11 delays the phase in the direction parallel to the plane of incidence relative to the phase in the direction perpendicular to the plane of incidence.

FIG. 13C shows the relationship between the angle of incidence of the light incident on the liquid crystal layer 11 and the contrast obtained in the presented image. The angle of incidence is expressed as θx as observed when θy=0°. In FIG. 13C, the solid line represents the contrast obtained when the birefringent film 17 is provided, and, for comparison, the broken line represents the contrast obtained when the birefringent film 17 is removed. In the image display apparatus 4, an image is presented by the use of light of which the center of the angle of incidence with respect to the liquid crystal layer 11 is Φ and of which the angular width is θ. FIG. 13C shows that the provision of the birefringent film 17 contributes to higher contrast in the image produced by that light.

In the image display apparatus 4, since the phase difference produced by the liquid crystal layer 11 in the X direction, in which the angle of incidence is expressed as θy, is small, this phase difference is not canceled. By contrast, since the phase difference produced by the liquid crystal layer 11 in the Y direction, in which the angle of incidence is expressed as θx, is large, this phase difference is canceled. As a result, it is possible to present an image with high contrast as a whole.

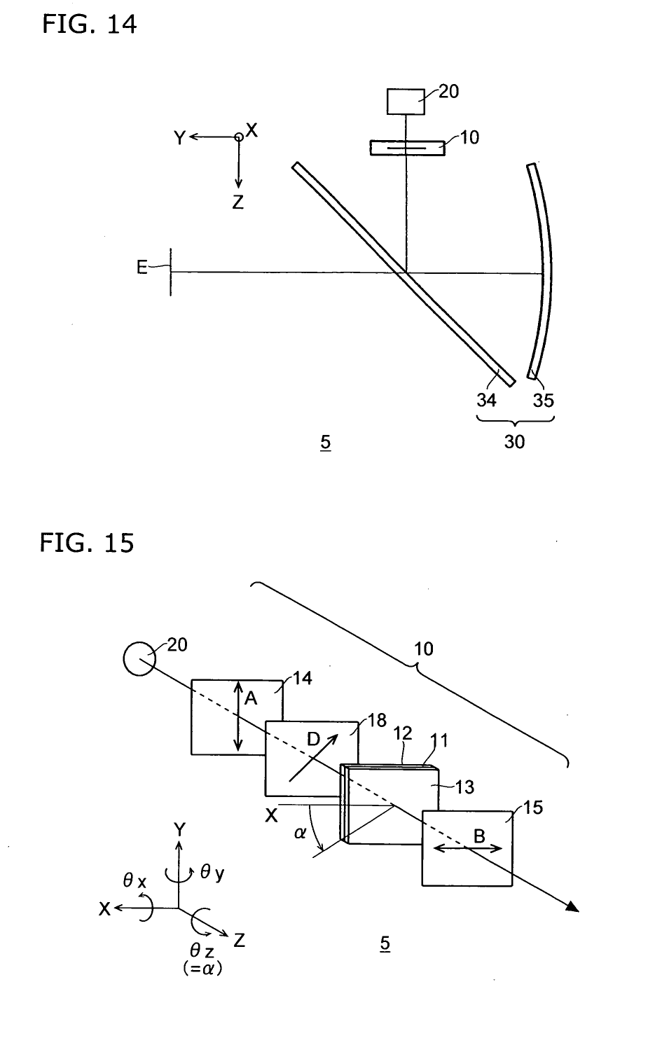

The optical construction of the image display apparatus 5 of a fifth embodiment of the invention is schematically shown in FIG. 14. The image display apparatus 5 includes: a display portion 10 including a transmissive liquid crystal layer 11 (see FIG. 15); an illumination portion 20 that feeds the liquid crystal layer 11 with illumination light; and a projection optical system 30 that presents an image by projecting the light representing the image that emerges from the display portion 10.

The illumination portion 20 has a similar construction to that provided in the image display apparatus 3 of the third embodiment, and is provided with, as a light source (not illustrated), a hybrid RGB light-emitting diode. In the image display apparatus 5, however, the illumination portion 20 is so designed that the principal ray of the illumination light therefrom is perpendicularly incident on the liquid crystal layer 11. That is, the illumination light is incident on the liquid crystal layer 11 at an angle of incidence of which the center is Φ (≠0°) and of which the angular width is θ (≠0°).

The projection optical system 30 is composed of a half mirror 34 and an axisymmetric concave mirror 35. The light representing an image from the display portion 10 is reflected from the half mirror 34, is then reflected from the concave mirror 35, is then transmitted through the half mirror 34 to reach the optical pupil E. An enlarged virtual image of the image displayed on the display portion 10 can be observed at the position of the optical pupil E. The distance from the optical pupil E to the virtual image is about several meters, and the size of the virtual image is ten or more times as large as that of the image displayed on the display portion 10.

The construction of the display portion 10 is schematically shown in FIG. 15. The display portion 10 has a similar construction to that of the image display apparatus 3 of the third embodiment. Here, however, instead of the birefringent film 17 arranged between the liquid crystal layer 11 and the second polarizing plate 15, a birefringent film 18 is provided between the first polarizing plate 14 and the liquid crystal layer 11. The liquid crystal layer 11 is formed of TN mode liquid crystal.

The birefringent film 18 is so designed that the phase difference it produces in light varies in the direction of the thickness thereof, and in addition that the direction of the principal refractive index of the refractive index ellipsoid thereof is inclined relative to the direction perpendicular to the birefringent film 18. The direction D of the component, parallel to the birefringent film 18, of the principal refractive index has a direction angle α of −135°, and forms angles of 45° with the polarization directions A and B of the linearly polarized light transmitted through the first and second polarizing plates 14 and 15.

Thus, the birefringent film 18 cancels the phase difference in the indecent light of which the plane of incidence is parallel to the direction D an perpendicular to the liquid crystal layer 11. Incidentally, the birefringent film 18 produces hardly any phase difference in the incident light of which the plane of incidence is perpendicular to the direction D, and thus does not change contrast in this direction, in which the phase difference produced by the liquid crystal layer 11 is small.

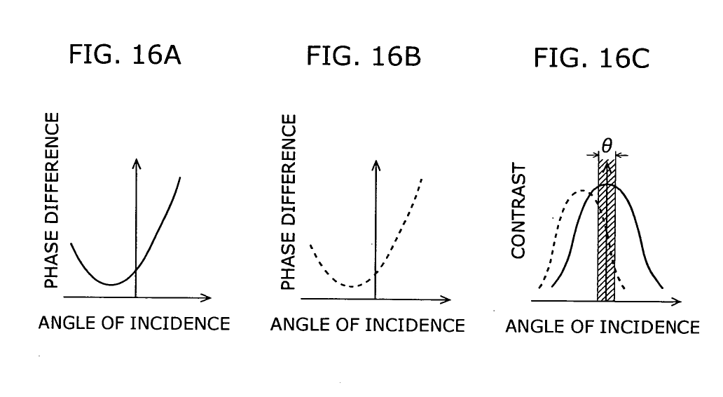

FIG. 16A schematically shows the relationship between the angle of incidence of the light incident on the birefringent film 18 and the phase difference produced by the birefringent film 18 in the light passing therethrough. The angle of incidence is that of the light of which the plane of incidence is parallel to the direction D and perpendicular to the liquid crystal layer 11. The birefringent film 18 acts in such a way as to advance the phase in the direction parallel to the plane of incidence relative to the phase in the direction perpendicular to the plane of incidence. On the other hand, as described above, the birefringent film 18 produces no phase difference in the direction parallel to the birefringent film 18 and perpendicular to the direction D of the above-mentioned component.

FIG. 16B shows the relationship between the angle of incidence of the light incident on the liquid crystal layer 11 and the phase difference produced by the liquid crystal layer 11 in the light passing therethrough as observed when the maximum voltage is applied to the liquid crystal layer 11, i.e., when it is in the non-displaying state. The angle of incidence is that of the light of which the plane of incidence is parallel to the direction D and perpendicular to the liquid crystal layer 11. The reason that the phase difference is represented with a broken line in FIG. 16B is that it has the opposite sign (indicating whether it is positive or negative) relative to that shown in FIG. 16A. That is, the liquid crystal layer 11 delays the phase in the direction parallel to the plane of incidence relative to the phase in the direction perpendicular to the plane of incidence.

To achieve quick response of alignment change in response to the switching of the applied voltage, the liquid crystal layer 11 is so designed that, when a voltage is applied thereto, i.e., when it is in the non-displaying state, the direction of the principal refractive index of the birefringence it produces is inclined relative to the direction perpendicular to the liquid crystal layer 11 (transparent substrates 12 and 13). As a result, the liquid crystal layer 11 produces the smallest phase difference at angles of incidence other than 0°.

Moreover, the direction D of the component parallel to the film surface of the birefringent film 18 is so set as to form an angle of 45° with the polarization direction A of the first polarizing plate 14, and thus the linearly polarized light is most affected by the phase difference within the plane of the birefringent film 18. This permits the phase difference produced by the birefringent film 18 shown in FIG. 16A to efficiently cancel the phase difference produced by the liquid crystal layer 11. Incidentally, the phase difference that is produced by the liquid crystal layer 11 in the incident light of which the plane of incidence is perpendicular to the direction D has a peak in the perpendicular direction, exhibits low dependence on angle, and is not affected by the birefringent film 18.

FIG. 16C shows the relationship between the angle of incidence of the light incident on the liquid crystal layer 11 and the contrast obtained in the presented image. The angle of incidence is expressed as θx as observed when θy=0°. In FIG. 16C, the solid line represents the contrast obtained when the birefringent film 18 is provided, and, for comparison, the broken line represents the contrast obtained when the birefringent film 18 is removed. In the image display apparatus 5, an image is presented by the use of light of which the center of the angle of incidence with respect to the liquid crystal layer 11 is Φ and of which the angular width is θ. FIG. 16C shows that the provision of the birefringent film 18 contributes to higher contrast in the image produced by that light.

In the image display apparatus 5, color images can be presented by providing the individual pixels of the liquid crystal layer 11 with corresponding color filters, or by feeding R, G, and B light on a time division basis from the illumination portion 20 and displaying the R, G, and B component of an image on a time division basis on the liquid crystal layer 11. Even when the latter method is adopted, since the direction of the principal refractive index of the liquid crystal layer 11 is inclined relative to the perpendicular direction to achieve quick alignment change, it is possible to present images with less flicker, permitting them to change smoothly. Moreover, by the latter method, it is possible to make the black matrix smaller and thereby increase the aperture ratio. This makes it possible to present high-contrast, bright color images.

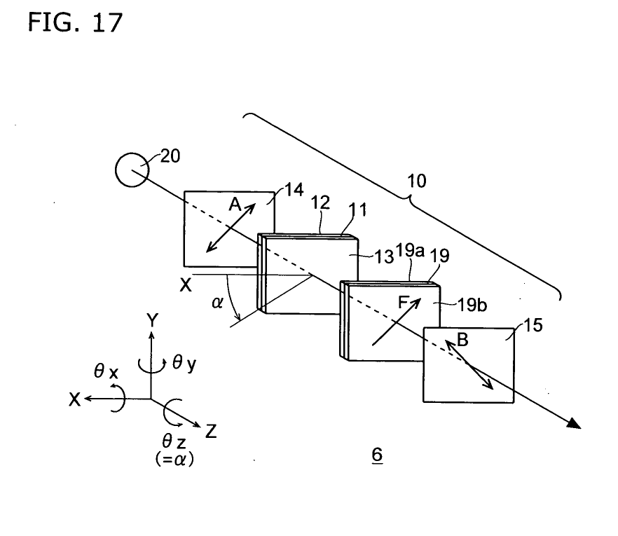

In the second to fifth embodiments, birefringent films 17 and 18 of which the principal refractive index is inclined by a fixed angle from the direction perpendicular to the film are used. Instead, a birefringent film of which the principal refractive index is inclined by a variable angle may be used. This makes it possible to vary the degree of cancellation of the phase difference according to the angle of incidence so that images are presented with the highest contrast irrespective of the angle of incidence. The construction of the display portion 10 of the image display apparatus 6, provided with such a birefringent film, of a sixth embodiment of the invention is schematically shown in FIG. 17.

This display portion 10 includes, in addition to a liquid crystal layer 11 for displaying an image (i.e., for producing light representing an image), transparent substrates 12 and 13 between which the liquid crystal layer 11 is held, a first polarizing plate (polarizer) 14, and a second polarizing plate (analyzer) 15, a liquid crystal layer 19 for canceling the phase difference produced by the liquid crystal layer 11. The direction angles α of the polarization directions A and B of the linearly polarized light transmitted through the first and second polarizing plates 14 and 15 are 45° and −45°, respectively.

The liquid crystal layer 19 is held between a pair of transparent substrates 19a and 19b, and is arranged between the liquid crystal layer 11 and the second polarizing plate 15. The liquid crystal layer 19 is formed of nematic liquid crystal, and the direction F of the principal refractive index thereof as observed when no voltage is applied thereto is parallel to the liquid crystal layer 19 (transparent substrates 19a and 19b). This direction F has a direction angle α of −135°, is parallel to the polarization direction A of the linearly polarized light transmitted through the first polarizing plate 14, and is perpendicular to the polarization direction B of the linearly polarized light transmitted through the second polarizing plate 15.

When no voltage is applied, the direction F of the principal refractive index is parallel to the liquid crystal layer 11, and thus the liquid crystal layer 19 produces no phase difference in any direction. On the other hand, when a voltage is applied, the direction F of the principal refractive index of the liquid crystal layer 19 is inclined relative to the liquid crystal layer 19, and thus the liquid crystal layer 19 produces a phase difference in the light of which the plane of incidence includes the direction F of the principal refractive index and is perpendicular to the liquid crystal layer 19. The magnitude of the inclination of the direction F of the principal refractive index relative to the liquid crystal layer 19 depends on the magnitude of the voltage applied to the liquid crystal layer 19. Thus, by adjusting the applied voltage, it is possible to adjust the degree of cancellation of the phase difference produced by the liquid crystal layer 19, i.e., the contrast obtained in the presented image.

Even when a uniform voltage is applied to the entire liquid crystal layer 19, the average contrast of the image can be adjusted according to the angle of incidence. However, since the angle at which light is incident on the liquid crystal layer 11 and the liquid crystal layer 19 varies from place to place, it is preferable to divide the liquid crystal layer 19 into a plurality of parts and apply different voltages to those parts. This makes it possible to adjust contrast so that the highest contrast is obtained in every part of the presented image. In this embodiment, the direction angle α of the direction F of the principal refractive index of the liquid crystal layer 19 is set at −135°. It is, however, also possible to set the direction angle α of the direction F at 0° or any other angle as in the first to fifth embodiments so that higher contrast is obtained in a desired direction.

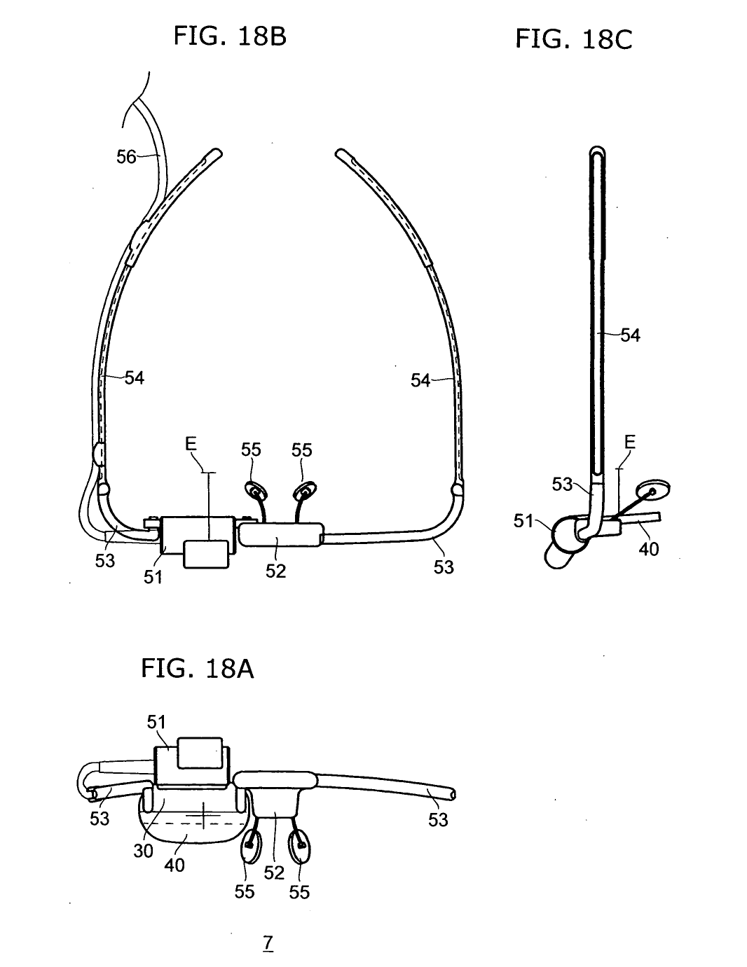

The exterior appearance of the image display apparatus 7 of a seventh embodiment of the invention is schematically shown in FIGS. 18A to 18C. FIG. 18A is a front view, FIG. 18B is a top view, and FIG. 18C is a side view. The image display apparatus 7 is so designed that the image display apparatus 3 of the third embodiment, which is so designed as to present a virtual image of the displayed image in a manner superimposed on part of the outside world, is worn by the user on the head. The image display apparatus 7 presents an image to one of the user's eyes (right eye).

The image display apparatus 7 includes a casing 51 in which the display portion 10 and the illumination portion 20 described earlier are housed and that is fixed to the top-end portion of the transparent substrate 31 constituting the projection optical system 30. The casing 51 is fitted to a bridge 52, and the casing 51 and the bridge 52 are each fitted with a frame 53. Moreover, each frame 53 is fitted with a temple 54, with a hinge fitted in between, and the bridge 52 is fitted with a pair of nose pads 55. The image display apparatus 7 as a whole is shaped like common spectacles with one lens removed. When the image display apparatus 7 is worn by the user, the temples 54 are supported on side faces of the head, and the nose pads 55 are supported on the nose.

To the casing 51 is connected a cable 56, via which electric power, a video signal, and a control signal are transmitted from an unillustrated controller to the display portion 10 and the illumination portion 20. The cable 56 is laid to run along one temple 54.

The image display apparatus 7 includes the birefringent film 17 in the display portion 10 thereof, and thus presents images with high contrast. Moreover, the user can wear the image display apparatus 7 without hardly feeling unnaturalness. Thus, the image display apparatus 7 can be suitably used in daily life. The transparent substrate 31 of the projection optical system 30 and the transparent substrate 40 for distortion correction may be given a curvature so as to provide a function of correcting the wearer's eyesight.

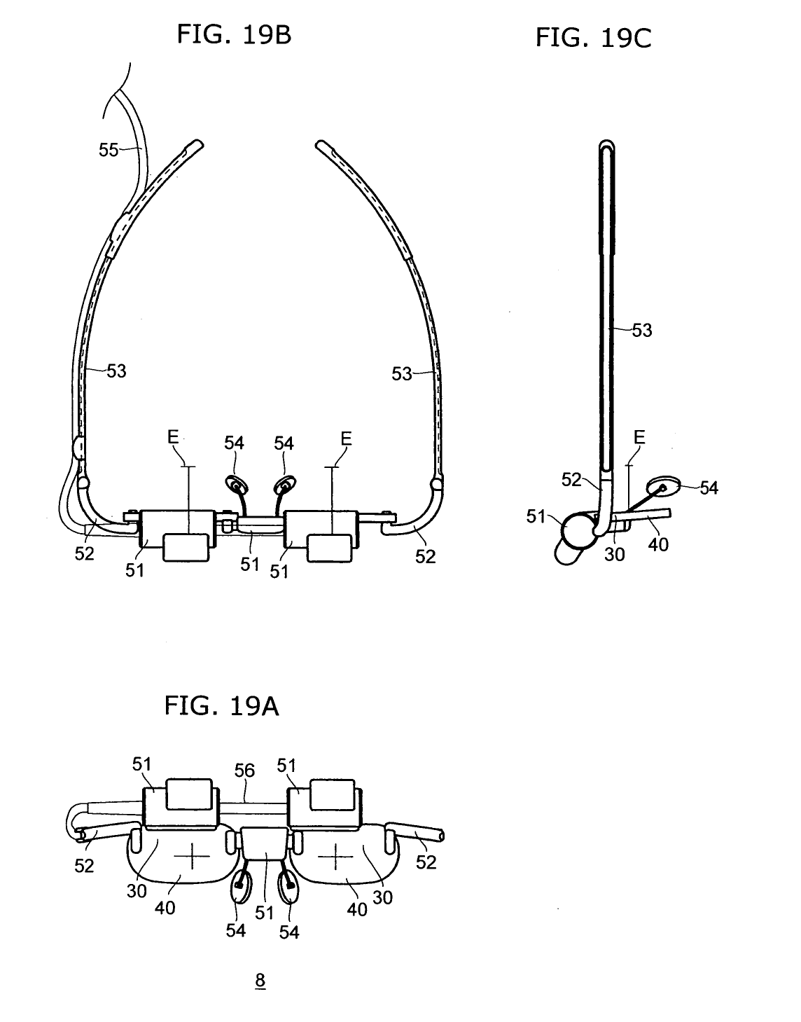

The exterior appearance of the image display apparatus 8 of an eighth embodiment of the invention is schematically shown in FIGS. 19A to 19C. FIG. 19A is a front view, FIG. 19B is a top view, and FIG. 19C is a side view. As compared with the image display apparatus 7 described above, the image display apparatus 8 is additionally provided with another set of the image display apparatus 3 of the third embodiment so that images are presented to both the right and left eyes. The cable 56 extends through one casing 51 to the other casing 51.

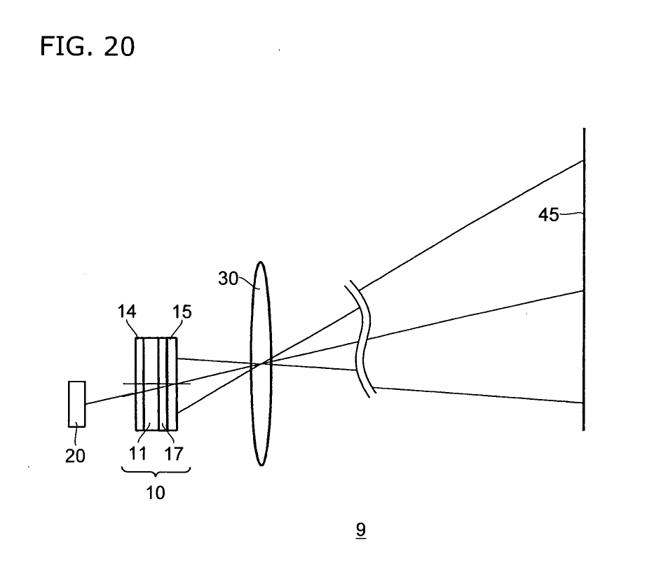

The optical construction of the image display apparatus 9 of a ninth embodiment is schematically shown in FIG. 20. The image display apparatus 9 is composed of a display portion 10, an illumination portion 20, a projection optical system 30, and a screen 45. The display portion 10 includes a liquid crystal layer 11 held between a pair of transparent substrates, a first polarizing plate (polarizer) 14, a second polarizing plate (analyzer) 15, and a birefringent film 17. The illumination portion 20 feeds the liquid crystal layer 11 with illumination light. The projection optical system 30 projects the light representing an image from the display portion 10 onto the screen 45 to form thereon an enlarged real image of the image displayed on the display portion 10.

The display portion 10 and the illumination portion 20 are so designed that the illumination light is obliquely incident on the liquid crystal layer 11. The projection optical system 30 is non-axisymmetric, and projects the light representing an image onto the screen 45 from an oblique direction. The birefringent film 17 is designed in a similar manner to that used in the image display apparatus 3 or 4 of the third or fourth embodiment so as to cancel the phase difference produced by the liquid crystal layer 11 as a result of the illumination light being obliquely incident on the liquid crystal layer 11. The image display apparatus 9, provided with the birefringent film 17, can present images with high contrast, i.e., with very low brightness in non-displaying, namely black, parts thereof, and is thus suitable for a projection-type television monitor.

Examples of a birefringent film that produces in light a phase difference varying in the direction of the thickness thereof as used in the first embodiment include non-drawn TAC film. Examples of a birefringent film that produces in light a phase difference varying in the direction of the thickness thereof and of which the direction of the principal refractive index is inclined as used in the second to fifth embodiments include WV film (manufactured by Fuji Photo Film Co., Ltd.) and NH film (manufactured by Nippon Oil Corporation).

For the purpose of canceling the phase difference produced by the liquid crystal layer for image display, it is also possible to use any material other than resin film so long as it produces in light a phase difference varying in the direction of the thickness thereof. Examples of such materials include calcite, sapphire, uniaxial crystal of quartz or the like, smectic liquid crystal, and nematic liquid crystal as used in the sixth embodiment.

The embodiments deal with examples where, as the liquid crystal layer 11, TN mode liquid crystal is used of which the liquid crystal molecules are aligned perpendicularly to the transparent substrate when the maximum voltage is applied and are aligned parallel to the transparent substrate and twisted 90° when no voltage is applied. It is, however, also possible to use liquid crystal of which the liquid crystal molecules, contrarily, are aligned perpendicularly to the transparent substrate when no voltage is applied and are aligned parallel to the transparent substrate and twisted 90° when the maximum voltage is applied. The present invention is applicable also in cases where liquid crystal of any other mode, such as OCB mode, IPS mode, or STN mode liquid crystal, is used as the liquid crystal layer 11. The embodiments deal with examples where the image display apparatus is designed as a transmissive image display apparatus. It is, however, also possible to design it as a reflective image display apparatus. It is also possible to omit the projection optical system to realize a direct-view-type image display apparatus.

Obviously, many modifications and variations of the present invention are possible in light of the above teachings. It is therefore to be understood that within the scope of the appended claims, the invention may be practiced other than as specifically described.

What is claimed is:

1. An image display apparatus comprising:
an illumination portion that emits illumination light;
a polarizer that transmits, of the illumination light emitted from the illumination portion, only linearly polarized light polarized in a predetermined polarization direction;
a liquid crystal layer that is held between a pair of transparent substrates and that turns the linearly polarized light transmitted through the polarizer into light polarized differently according to magnitude of a voltage applied to the liquid crystal layer;
an analyzer that transmits, of light emerging from the liquid crystal layer, linearly polarized light polarized in a predetermined polarization direction;
a projection optical system that projects the linearly polarized light transmitted through the analyzer; and
a phase difference producing member that produces in the linearly polarized light traveling from the polarizer through the liquid crystal layer to the analyzer a phase difference in such a direction as to cancel a phase difference produced by the liquid crystal layer according to angle of incidence.

2. The image display apparatus of claim 1,
wherein the projection optical system is non-axisymmetric.

3. The image display apparatus of claim 2,
wherein the liquid crystal layer is formed of TN mode liquid crystal.

4. The image display apparatus of claim 1,
wherein the phase difference producing member is a phase difference film having birefringence such that the phase difference that the phase difference producing member produces in light varies in a direction of thickness thereof.

5. The image display apparatus of claim 4,
wherein a direction of a principal refractive index of a refractive index ellipsoid of the phase difference film is inclined relative to a direction perpendicular to the phase difference film.

6. The image display apparatus of claim 3,
wherein a direction of a principal refractive index of the liquid crystal layer as observed when no image is being displayed is inclined relative to a direction perpendicular to the transparent substrates.

7. The image display apparatus of claim 5,
wherein an angle between the polarization direction of the linearly polarized light transmitted through the polarizer and a component, parallel to the transparent substrates, of the direction of the principal refractive index of the refractive index ellipsoid of the phase difference film is larger than 0° but smaller than 90°.

8. The image display apparatus of claim 5,
wherein an angle between the polarization direction of the linearly polarized light transmitted through the polarizer and a component, parallel to the transparent substrates, of the direction of the principal refractive index of the refractive index ellipsoid of the phase difference film is equal to 45°.

9. The image display apparatus of claim 6,
wherein an angle between the polarization direction of the linearly polarized light transmitted through the polarizer and a component, parallel to the transparent substrates, of a direction of a principal refractive index of a refractive index ellipsoid of the phase difference producing member is larger than 0° but smaller than 90°.

10. The image display apparatus of claim 6
wherein an angle between the polarization direction of the linearly polarized light transmitted through the polarizer and a component, parallel to the transparent substrates, of a direction of a principal refractive index of a refractive index ellipsoid of the phase difference producing member is equal to 45°.

11. The image display apparatus of claim 1,
wherein the projection optical system projects the linearly polarized light emerging from the analyzer into a user's eye to present a virtual image of an image.

12. An image display apparatus comprising:
an illumination portion that emits illumination light;
a polarizer that transmits, of the illumination light emitted from the illumination portion, only linearly polarized light polarized in a predetermined polarization direction;
a TN mode liquid crystal layer that is held between a pair of transparent substrates and that turns the linearly polarized light transmitted through the polarizer into light polarized differently according to magnitude of a voltage applied to the liquid crystal layer; and
a phase difference producing member that has birefringence such that a phase difference that the phase difference producing member produces in light varies in a direction of thickness thereof and that produces in the linearly polarized light traveling from the polarizer through the liquid crystal layer to the analyzer a phase difference in such a direction as to cancel a phase difference produced by the liquid crystal layer according to angle of incidence,
wherein a direction of a principal refractive index of a refractive index ellipsoid of the phase difference producing member is inclined relative to a direction perpendicular to the transparent substrates, and
wherein an angle between the polarization direction of the linearly polarized light transmitted through the polarizer and a component, parallel to the transparent substrates, of the direction of the principal refractive index of the refractive index ellipsoid of the phase difference producing member is larger than 0° but smaller than 90°.

13. The image display apparatus of claim 12,
wherein the angle between the polarization direction of the linearly polarized light transmitted through the polarizer and the component, parallel to the transparent substrates, of the direction of the principal refractive index of the refractive index ellipsoid of the phase difference producing member is equal to 45°.
